(19) United States
(12) Patent Application Publication
(10) Pub. No.: US 2004/0255186 A1
(43) Pub. Date: Dec. 16, 2004

(54) Methods and apparatus for failure detection and recovery in redundant systems

(75) Inventor: Man Fai Lau, Summit, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ

(21) Appl. No.: 10/445,541

(22) Filed: May 27, 2003

(51) Int. Cl. H02H 3/05

(52) U.S. Cl. 714/6

(57) ABSTRACT

Techniques and systems for managing failure recovery in redundant systems are described. A pair of redundant system units includes a first unit and a second unit, one of which operates as a primary unit and one of which operates as a backup unit. Upon initiation of operation of a system unit, that unit enters an initial status as the backup unit, so that simultaneous initiation of both units causes a status conflict. Recognition of a status conflict causes status negotiation, so that one unit is designated the primary unit and the other the backup unit. Upon failure of a unit, the other unit checks its status and continues operation if it is the primary unit or transitions to become the primary unit if it is the backup unit. Upon replacement, the failed unit is initialized, being designated as the backup unit. The operating unit continues operation as the primary unit.

### FIELD OF THE INVENTION

The present invention relates generally to improved systems and techniques for failure recovery. More particularly, the invention relates to systems and techniques for managing the recovery of redundant system elements comprising a primary element active during normal operation and a backup element becoming active upon failure of the primary element, with recovery being managed in such a way as to minimize the number of times that an element undergoes a transition between identification as the primary element and identification as the backup element.

### BACKGROUND OF THE INVENTION

Many devices include redundant hardware elements, so that if one of the redundant elements fails, operation can continue without outside intervention. For example, a subsystem, such as a controller for a network server, may include a primary and a backup control board. If the primary board fails, the backup board detects the failure of the primary board and undergoes a transition so that the backup board begins functioning as the primary board. In many prior art systems, repair or replacement of the primary board and reactivation of the subsystem causes the backup board to recognize that the primary board has returned to operation. In such a case, the backup board undergoes another transition in function, so that the original backup board once again functions as the backup board and the repaired or replacement primary board functions as the primary board.

For many networking applications, it is convenient to implement a redundant subsystem with an Ethernet switch or similar switch controlling access to the system by external elements or components. For example, a control subsystem may operate as a server, receiving and servicing requests transmitted from various clients on a network. The primary and the backup control board for such a subsystem may share a connection to an Ethernet switch having a network address. Service requests or other communications intended for the subsystem are directed to the address of the Ethernet switch. The Ethernet switch may be enabled or disabled as required in order to make the control subsystem accessible or inaccessible to network clients. When a board fails, the Ethernet switch may be disabled in order to prevent service requests from reaching the subsystem, in order to allow time for a backup board to transition to operation as the primary board.

The enabling and disabling of the Ethernet switch is typically controlled by software that identifies the operational mode of the controller subsystem and controls the switch in order to connect or isolate the subsystem, as required by the operational mode. For example, the controller subsystem may be operating normally. In this case, the switch would be set to allow communication with outside elements. Alternatively, a failure may be detected, requiring a backup board to transition to operation as the primary board. In this case, the switch would be set to isolate the controller system as soon as the failure was detected, and the controller subsystem would remain isolated until the transition had been completed. After the transition had taken place successfully, the former backup element would have completed the transition to function as the primary element, and the switch could be enabled to allow service requests to reach the controller subsystem again.

The recovery system imposes a performance penalty, particularly when a transition is made so that a backup element becomes a primary element. During the transition from backup to primary, processing operations such as the handling of service requests may stop until the transition is complete. There exists, therefore, a need for systems and techniques that will allow recovery upon failure detection in redundant systems, while managing operation and recovery of the redundant systems in such a way that a reduced number of transitions occurs.

### SUMMARY OF THE INVENTION

A system according to an aspect of the present invention suitably comprises a pair of redundant units, with one member of the pair being the primary unit, active during normal operation, and the other member of the pair being the backup unit, which transitions to become the primary unit upon failure of the unit that was initially the primary unit. One example of such a system is a network server. The network server may suitably include a plurality of processing boards whose operation is managed by the active, or primary, member of a pair of redundant control boards. In this exemplary application, one of the boards is a primary board active during normal operation and the other board is a backup board that undergoes a transition to become the primary board if the primary board fails. The control boards suitably share a connection to an Ethernet switch, which allows connection to the system by external elements requiring processing services.

Upon initial bootup of the system, each of the control boards identifies itself as the backup board and sends messages to the other. The sending of messages continues during normal operation of the system, with each message including information identifying the status of the board sending the message. Immediately after initial bootup, each message indicates that the board sending the message is the backup board. However, during initial bootup, a status negotiation takes place. During this status negotiation, one of the boards will be identified as the primary board and the other board will be identified as the backup board. After this occurs, each message will indicate whether the board sending the message is the primary or the backup board.

When a board receives a message that indicates that the board sending the message is has the same status as the board receiving the message, a status conflict occurs. That is, if both boards have a status as primary board, a status conflict exists and if both boards have a status as backup board, a status conflict exists. Normally, a status conflict occurs only upon initial bootup, after both boards have declared themselves to be the backup board and exchanged messages.

Upon recognition of a status conflict, both boards negotiate their status, suitably by examining a set of jumper connections. During status negotiation, one of the boards is identified as the primary board and one is identified as the backup board. The boards then enter a steady state, with the primary board servicing requests and with both boards sending messages to one another identifying their status. Upon failure of one board, the other board detects that messages have stopped and enters a failure analysis mode. If the operating board is the primary board, it notes the failure and continues operation. If the operating board is the backup board, it notes the failure, transitions to become the primary board and resumes operation. Upon replacement of the failed board, the replacement board enters an initial boot state, identifying itself as the backup board and sending messages to and receiving messages from the operating board. Upon receiving messages from the replacement board, the operating board clears any failure indicator. The replacement board receives messages from the operating board, but does not note any conflict because the replacement board has been identified as the backup board at its initial boot and the operating board is operating as the primary board. The replacement board then enters the steady state as the backup board.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a redundant system according to an aspect of the present invention;

FIG. 2 illustrates a control module according to an aspect of the present invention;

FIG. 3 illustrates a redundant system according to an alternative aspect of the present invention; and

FIG. 4 illustrates a method of failure sensing and recovery in redundant systems according to an aspect of the present invention.

### DETAILED DESCRIPTION

The present invention will be described more fully hereinafter with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

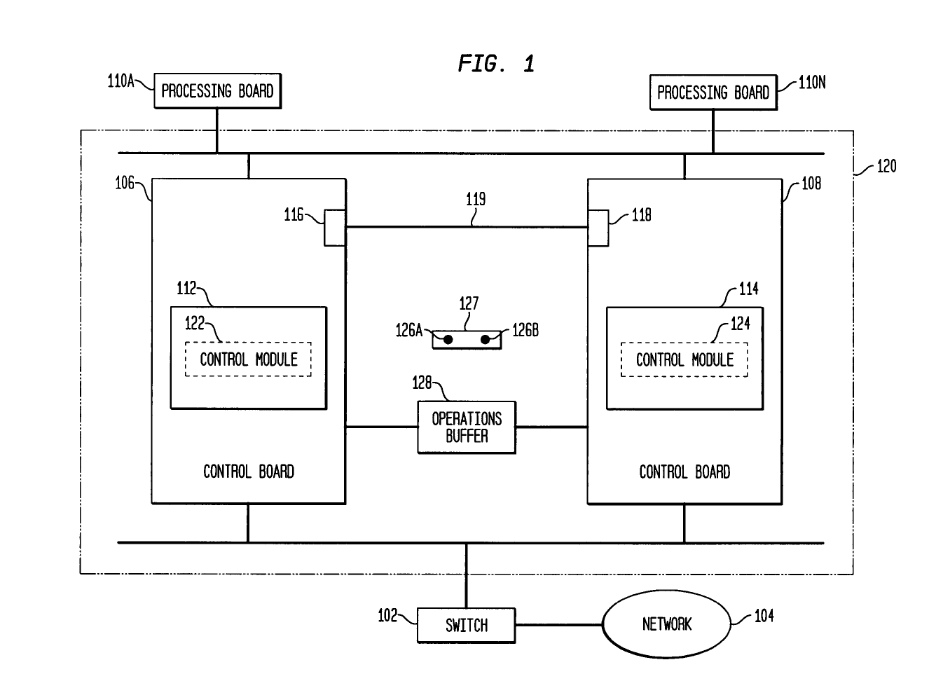

FIG. 1 illustrates a system 100 according to an aspect of the present invention. The system 100 provides services to one or more external clients submitting service requests to the system 100. The external clients may suitably submit service requests to the system 100 through an Ethernet switch 102, accessible through a network 104. The Ethernet switch 102 provides the system 100 with an internet protocol (IP) address, so that requests addressed to the IP address of the switch 102 will be directed to the system 100.

The system 100 includes a pair of redundant control units, implemented here as a pair of control boards 106 and 108. The control boards 106 and 108 are suitably identical, with each being connected to the switch 102 and with one of the boards 106 and 108 serving as a primary control board and one serving as a backup control board. The primary control board fulfills service requests, while the backup control board monitors the status of the primary control board and transitions to become the primary control board if it detects that the primary control board has failed. The system 100 also includes a plurality of processing boards 110A . . . 110N. Each of the processing boards 110A . . . 110N may suitably provide processing capability typical of a personal computer, and each of the processing boards 110A . . . 110N performs processing in order to fulfill service requests directed to it by the primary control board.

Each of the control boards 106 and 108 suitably includes memory 112 and 114, respectively. The control boards 106 and 108 also include connection ports, suitably serial ports 116 and 118, respectively. The serial ports 116 and 118 may suitably be connected through a connector 119, in order to allow communication between the control boards 106 and 108. The connector 119 may suitably be an element of a backplane 120.

The control board 106 hosts a control module 122, suitably implemented as software residing in the memory 112. The control board 108 hosts a control module 124, identical to the control module 122 and implemented as software residing in the memory 114. The boards 106 and 108 have access to a set of jumper connections. The jumper connections are used to designate which of the boards 106 and 108 is identified as the primary board when status negotiation occurs as a result of a status conflict. Because a single choice among two alternatives is to be made, the set of jumper connections implemented here includes a single pair of connectors, the connectors 126A and 126B. When the connectors 126A-126B are connected by a jumper such as the jumper 127, the board 106 is designated as the primary board. When the jumper 127 is not present and the connectors 126A and 126B are not connected, the board 108 is designated as the primary board. A status conflict typically occurs at initial bootup, when each of the boards 106 and 108 is in an initial status as the backup board. The status conflict causes negotiation of status and examination of the jumper connections 126A and 126B.

Each of the boards 106 and 108 operates in one of three operational modes, as determined by the control module for that board. Typically, both of the boards 106 and 108 operate in the same operational mode unless one of the boards has failed. The first operational mode is an initial boot mode, during which the boards 106 and 108 negotiate which is to be primary and which is to be backup. The second state is a steady state mode, in which one of the boards 106 and 108 operates as primary and the other operates as backup and messages are regularly transferred between the boards 106 and 108. The third mode is a failure analysis mode, entered into by one of the boards 106 and 108 when the other board is detected to have failed. An operating board detects that the other board has failed when messages are no longer being received from the other board.

At initial powerup of either of the boards 106 and 108, the board enters the initial boot mode. At this point, the board entering the initial boot mode declares itself to be the backup board. When a new or repaired board is being substituted for a failed board without powering down the system 100 as a whole, only the replacement board enters the initial boot mode. However, at initial powerup of the system 100, both of the boards 106 and 108 enter the initial boot mode. Once a board has declared itself to be in a particular status, that is, once it has declared itself to be the primary board or the backup board, it sends messages to the other board identifying its status. The transfer of messages allows each board to determine whether or not the other board is continuing to operate, and also allows each board to check for a status conflict by comparing its own declared status against the status of the other board as indicated in the messages received from the other board.

The general operation of the system 100 will now be described. Initially, the system 100 is shut down. When the system 100 is powered up, both of the boards 106 and 108 are powered up and enter the initial boot mode. Both boards declare themselves to be the backup board. The boards 106 and 108 relay messages to one another. Because each board is identified as the backup board and because each board detects that the other is also identified as the backup board, a status conflict occurs. Both of the boards 106 and 108 examine the jumper connectors 126A and 126B. Because the jumper 127 is present, the board 106 is identified as the primary board and the board 108 is identified as the backup board.

Once the board 106 has been designated as the primary board and the board 108 has been designated as the backup board, the boards 106 and 108 enter the steady state mode of operation, during which messages are exchanged between the primary and the backup board and service requests are fulfilled by the primary board. Messages are transferred by a connection between boards, for example through the serial ports 116 and 118, and the connector 119. The elements making up the connection, such as the elements 116, 118 and 119, are preferably designed in such a way that each of the boards 106 and 108 can distinguish a failure of the connection from a failure of the other board. If a connection failure occurs such that both of the boards erroneously detect a failure of the other boards, each of the boards 106 and 108 will declare itself to be the primary board and will attempt to operate as the primary board. If both boards attempt to operate as the primary board, the system 100 will operate incorrectly, possibly causing erroneous data to be delivered to external clients. Therefore, the elements 116, 118 and 119 and the control boards 106 and 108 are designed so that a connection failure is properly identified. This design may be accomplished using any of a number of techniques known in the art. For example, the connector 119 may suitably be designed to deliver a low level signal to each of the boards 106 and 108. If the boards 106 and 108 fail to detect this low level signal, they will recognize a connection failure and follow predetermined failure protocols, such as directing that the system 100 be shut down, disconnecting the switch 102 and alerting an operator.

During normal operation of the system 100, each of the boards 106 and 108 continues to send messages to the other board at frequent intervals. When a board is receiving messages that are consistent with its self identification, for example when the primary board receives messages identifying the other board as the backup board, there is no need to perform negotiation in order to resolve the status of the boards. When either of the boards 106 and 108 receives a message inconsistent with its own self identification, it renegotiates its status. Typically, this condition occurs only during the initial boot state described above, during which both boards initially identify themselves as the backup board.

During the steady state mode, the board 106 receives and services requests, while periodically sending messages to the board 108. If the messages stop, the board 108 will recognize that the messages have stopped and will thus detect that the board 106 has failed. At the same time, the board 108 periodically transmits messages to the board 106, identifying the status of the board 108 and allowing the board 106 to detect a cessation of messages from the board 106 and thus a failure of the board 108.

Some applications in which a system such as the system 100 may be used require that the system 100 maintain information relating to the specific tasks being accomplished. For example, if the system 100 is used in a call center, the board 106 may be used to direct each data stream generated by an incoming call to an appropriate one of the processing boards. The data stream for a first call may be directed to the processing board 110A, the data stream for the second call may be directed to the processing board 110B, and so on. If the board 106 fails, it is necessary to maintain the information needed to maintain proper associations between callers and the processing boards handling their calls and to transfer this information to the board 108 if the board 106 fails. Therefore, suitable techniques known in the art are employed to maintain and transfer this information when necessary. The choice of technique and the methods for using the technique may be integrated into the design of the system 100. For example, an operations buffer 128 may be employed to store information used in operations, when this information is needed after failure of the board 106 and transition of the board 108 to operate as the primary board. During the transition to operation as the primary board, the board 108 will retrieve the stored information from the operations buffer 128. Other alternative techniques may be used to restore operational information, or the restoration of operational information need not be accomplished if it is not called for by the application in which a system such as the system 100 is to be used.

Now, suppose the board 108, that is, the backup board, fails. When the board 108 fails, the board 106 detects that messages are no longer being received from the board 108. The board 106 enters a failure analysis mode, but no change of status of the board 106 occurs. Instead, the board 106 recognizes the failure of the board 108. The board 106 logs the failure of the board 108 to allow notification to an operator that the board 108 has failed, so that the operator may replace the backup board at a convenient time. The board 106 then returns to the steady state mode of operation. The board 106 does not enter the initial boot mode and does not undergo a transition in status. Entry of the board 106 into a failure analysis mode does not inhibit servicing of requests. Aside from noting and logging the failure of the board 108, the board 106 continues operation as if no failure of the board 108 had occurred.

The system 100 is preferably adapted to undergo component replacement without powering down the system 100 as a whole. Thus, any components of the system 100 that are operating will continue without interruption during replacement of a failed component. Specifically, when a failed control board is replaced, the operating control board, which is typically acting as the primary board by the time of the replacement, will not power down during the replacement of the failed control board. Only the replaced control board will power up and enter the initial boot mode upon replacement. Therefore, if the board 108 is replaced, only the board 108 will enter the initial boot mode upon powerup. The replacement board may be referred to as the board 108. The board 108 will identify itself as the backup board and will begin to transfer messages to the board 106. The board 106 will receive messages from the board 108 and will transfer messages to the board 108. No status conflict will occur, because both boards will receive messages consistent with their own self-identification. The board 106 will recognize that the board 108 is operating again and the board 108 will enter the steady state mode of operation.

After replacement of the board 108, the system 100 proceeds to operate in a normal operational state. There is no significant difference between the condition of the system 100 after replacement of the board 108 and the condition that the system 100 would have been in if the board 108 had not failed.

Now, suppose that the board 106, that is, the primary board, fails. When the board 106 fails, the board 108 detects that no messages are being received from the board 106. The board 108 then enters the failure analysis mode, during which it undergoes a transition to become the primary board. This transition may include the retrieval of operational information, for example, information stored in the buffer 126, in order to allow the board 108 to proceed with the operations that were being performed by the board 106 before the failure. Once the transition is complete, the board 108 logs the failure of the board 106 and notifies an operator in order to alert the opportunity to replace the board 106. The board 108, now acting as the primary board, enters the steady state mode of operation. As primary board, the board 108 takes over the functions of managing the switch 120 and fulfilling service requests. Any service requests that went unfulfilled due to the failure of the board 106 can be expected to be resubmitted by the clients that previously submitted the requests. These resubmitted requests, and all other service requests, will be received and fulfilled by the board 108 as it functions as the primary board.

Now, suppose that the board 106 is replaced. The replacement board 106 will now be referred to as the board 106. At initial boot, the board 106 declares itself to be the backup board and the board 108 continues to identify itself as the primary board. The board 108 transmits messages declaring itself to be the primary board and the board 106 transmits messages declaring itself to be the backup board. No status conflict occurs, so there is no reason to perform negotiation. The board 108 does not undergo another transition to become backup board, as was its state before the board 106 failed. Instead, the board 108 simply remains in its new state, without a need to undergo another transition.

The above description of the replacement of the board 106 assumes that replacement occurs without powering down the system 100. It is possible to employ systems such as the system 100 in applications in which the system must power down in order to replace a failed component. In such a case, both of the boards 106 and 108 would perform bootup when the system was again powered up, and the primary board would be determined by the presence or absence of the jumper 127. A transition of one of the boards 106 and 108 from backup to primary would occur in such a situation.

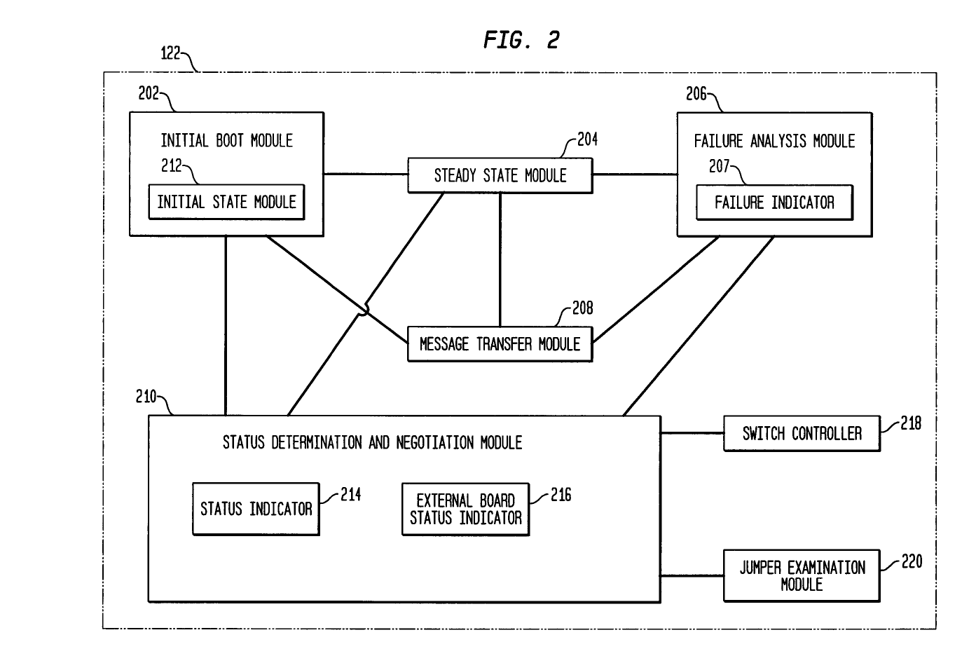

FIG. 2 illustrates the control module 122 in additional detail. The control module 124 is identical, and will not be described in detail here, in order to avoid repetition. The control module 122 includes an initial boot module 202, a steady state module 204 and a failure analysis module 206. The failure analysis module 206 includes a failure indicator 207. The control module 122 also includes a message transfer module 208 and a status determination and negotiation module 210. The initial boot module 202 includes an initial state module 212.

The initial boot module 202 operates upon initial powerup of the board 106. The initial state module 210 is invoked, and sets the status of the board 106 to that of the backup board. The initial boot module 202 then invokes the message transfer module 208, which sends messages to the board 108 to identify the status of the board 106, and receives messages from the board 108 in order to identify the status of the board 108. The initial state module 212 sends status information to the status determination and negotiation module 210. The status determination and negotiation module 210 sets a status indicator 214 to indicate a backup status. The message transfer module 208 receives information about the status of the board 108 and transfers that information to the status determination and negotiation module 210. The status determination and negotiation module sets an external board status indicator 216. Because the board 108 is also in its initial boot state, the status of the board 108 is set to backup and the external board status indicator 216 is set to backup. The status determination and negotiation module 210 examines the status indicator 214 and the external board status indicator 216 to determine if a conflict exists. If the status indicator 214 and the external board status indicator 216 indicate different settings, no negotiation occurs. However, as is the case during initial boot, the status indicator 214 and the external board status indicator 216 indicate the same setting, a conflict is present and negotiation must occur. In such a case, the status determination and negotiation module 210 sets a switch controller 218 to disconnect the Ethernet switch 102, and invokes the jumper examination module 220 to examine the jumper settings. The status determination and negotiation module 210 sets the status indicator 214 to the setting indicated by the jumper settings.

As an example, suppose that the jumper 127 is present, so that the jumper settings indicate that the board 106 is to be the primary board. The status indicator 214 is set to indicate that the board 106 is the primary board. The status determination and negotiation module then sets the switch controller 220 to connect the Ethernet switch 102, and invokes the steady state module 204. The steady state module 204 manages service requests, while the status determination and negotiation module 210 periodically directs the message transfer module 208 to send messages indicating the status of the board 106. At the same time, the status determination and negotiation module 210 examines messages received from the board 108 in order to discover a change in status of the board 108.

If the board 108 fails, the message transfer module 208 will no longer detect messages being received from the board 108. The steady state module 204 will then invoke the failure analysis module 206. The failure analysis module 206 sets the failure indicator 207 to indicate that the board 108 has failed, and prepares a message for an operator, so that the operator will be alerted to replace the board 108. The failure analysis module 206 then examines the status indicator 214 to determine the status of the board 106. If the status indicator 214 indicates that the board 106 is operating as the primary board, the failure analysis module 206 invokes the steady state module 204 and the board 106 returns to steady state operation. The message transfer module 208 will send messages to be relayed to the board 108, and will look for messages from the board 108. However, the failure to receive messages will not cause the steady state module 204 to invoke the failure module 208, because the failure of the board 108 has already been logged.

Alternatively, suppose that the jumper 127 is absent, so that the board 106 is operating as the backup board and the board 108 is operating as the primary board. The board 108 fails. The steady state module 204 invokes the failure analysis module 206 and the failure analysis module 206 sets the failure indicator 207 to indicate that the board 108 has failed, and examines the status indicator 214. The status indicator 214 indicates that the board 106 is operating as the backup board, and so status determination and negotiation module 210 is invoked. The status determination and negotiation module 210 disconnects the Ethernet switch 102 and changes the setting of the status indicator 214 to indicate that the board 106 will operate as the primary board. The status determination and negotiation module 210 then connects the Ethernet switch 102 and invokes the steady state module 204. The board 106 begins operation in the steady state mode as the primary board and service requests, transfers messages to the board 108 and looks for messages from the board 108.

Once the board 108 is replaced, it boots and declares itself to be the backup board. The message transfer module 208 begins to receive messages from the board 108, declaring the board 108 to be the backup board. The message transfer module 208 notifies the steady state module 204 that messages are being received from the board 108 and the steady state module 204 clears the failure indicator 207. The board 106 remains in operation as the primary board, because it was operating as the primary board before the board 108 was replaced, and no status conflict is recognized. The board 106 is operating as the primary board and receiving messages that indicate that the board 108 is the backup board. Because the failure indicator 207 has been cleared, failure of the board 108 will cause invocation of the failure analysis module 206 and entry into a failure analysis mode, but until a failure is detected the board 106 will continue to operate as the primary board in the steady state.

A system such as that described above can be used in a number of different applications. For example, an internet service provider may suitably employ a system such as the system 100 may be used to provide a virus free downloading service. A download request would pass through the primary board and be routed to one of the processing boards 110A . . . 110N. For example, the request might be routed to the processing board 110A. The board 110A would direct the request to the server indicated in the request, and would receive the data from the server. As the downloaded data was received from the server, the board 110A would examine the data for viruses and either remove any viruses or abort the download, according to predetermined rules and any user preferences. The downloaded data would then be directed to the primary board, which would transfer it to the user.

Another application might be a web redirection application, employed by an Internet content provider hosting content on a server that was mirrored in a number of different geographic locations. A user might enter the advertised address of the content provider, and this address would direct the user to a system such as the system 100. The primary control board would connect the user to one of the processing boards 110A . . . 110N. The processing board would examine the user's address and determine the geographic location of the user. The board would then select the best mirror site for the user, based on such considerations as geographic location of the mirror site and capacity and load of the mirror site. Each of the processing boards 110A . . . 110N could be dedicated to servicing and routing data streams for one or more users, with the primary control board directing user requests to the appropriate processing boards. Other applications might include an automated call center, wherein a caller is serviced by a processing board and the primary control board routes data streams to and from the appropriate processing boards.

It will be recognized that the present invention may advantageously be employed in applications other than the provision of processing services to clients on a network. For example, various hardware components may advantageously be designed with redundant elements employing the teachings of the present invention.

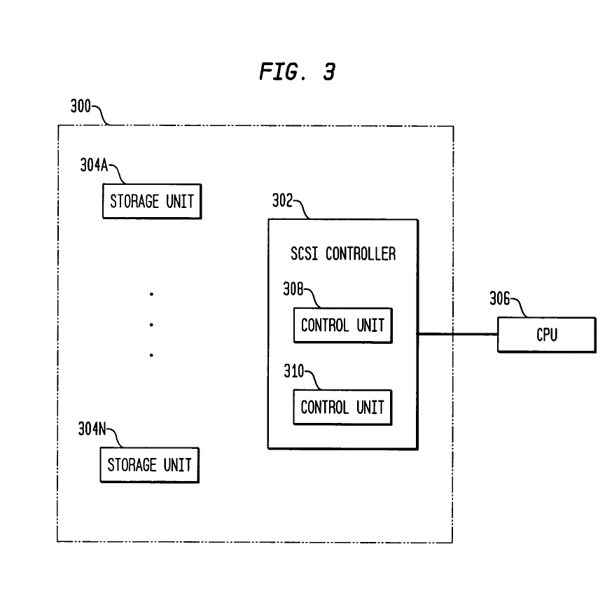

FIG. 3 illustrates a data storage system 300 according to an aspect of the present invention. The system 300 includes a small systems control interface (SCSI) controller 302, as well as a plurality of storage units 304A . . . 304N. The controller 302 receives access requests from a central processing unit (CPU) 306, and processes the requests in order to access the correct one of the storage unites 304A . . . 304N and to read or write data as directed by the CPU 306. The controller 302 includes a pair of redundant control units 308 and 310. One of the control units functions as the primary unit, and the other unit functions as the backup unit. Communication between the units 308 and 310, and failure detection, recovery and replacement are managed in a way similar to that described above with respect to the system 100 of FIG. 1. Numerous other systems can be envisioned that have redundant components and employ the techniques of the present invention to minimize transitions. One example of such a system is a redundant power supply, in which a backup supply transitions to become the primary, and remains the primary when the failed supply is replaced. Another example might be a recording device, for example a “black box” carried in an airplane, having redundant recording units. Numerous other examples can be implemented, with the teachings of the present invention used to increase service time by reducing the number of transitions between a backup unit and a primary unit.

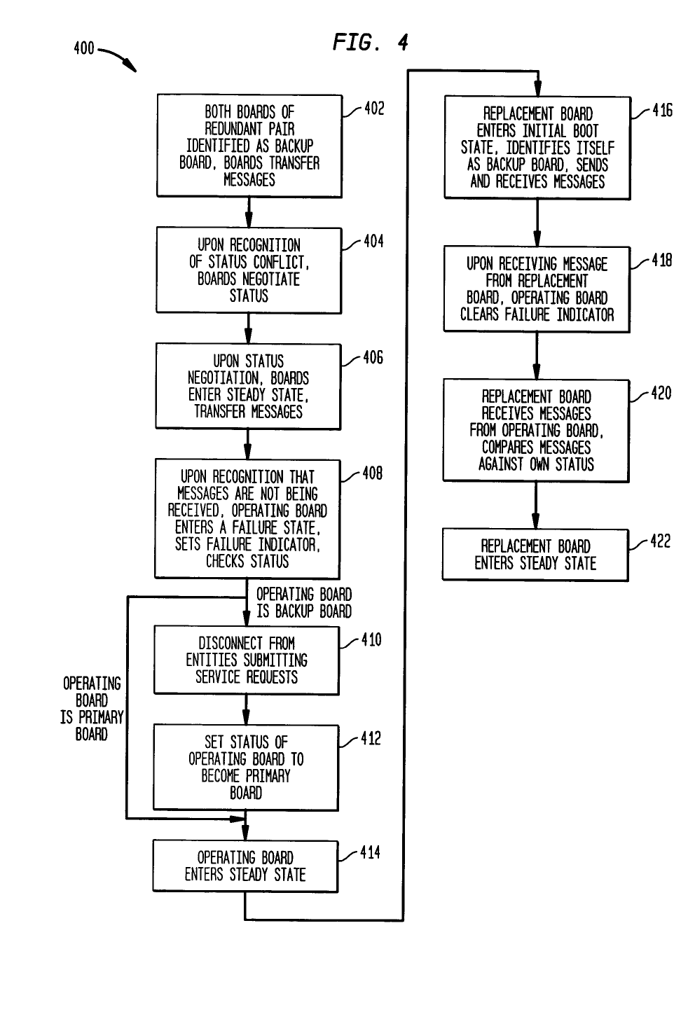

FIG. 4 illustrates the steps of a process 400 of failure recovery in redundant systems according to an aspect of the present invention. The process 400 may suitably be implemented using a system such as the system 100 of FIG. 1. At step 402, at initial powerup of a system comprising a pair of redundant control boards, both boards of the pair identify themselves as the backup board and send messages to one another identifying themselves as the backup board. At step 404, upon recognition of a status conflict between its own status and the status of the other board, each board performs status negotiation by examining jumper connections and setting its status in accordance with the jumper connections. At step 406, after its status has been set, each board enters a steady state, with one board being the primary board and the other board being the backup board. The primary board performs operations such as fulfilling service requests, while both boards transfer messages to one another identifying their status. At step 408, upon recognition by one board that messages from the other board are not being received, the operating board enters a failure analysis mode, setting a failure indicator to indicate that the defective board has failed, and examining its own status. If the operating board is the primary board, the process skips to step 414. If the operating board is the backup board, the process proceeds to step 410 and the operating board disconnects from entities submitting service requests, suitably by disconnecting an Ethernet switch. The process then proceeds to step 412 and the operating board then sets its status to become the primary board. The process then proceeds to step 414 and the board enters the steady state.

At step 414, there is only one board operating and it is the primary board, either because it was originally the primary board or because it transitioned to become the primary board upon failure of the board which was previously acting as the primary board. The following steps of the process occur after replacement of the failed board.

At step 416, the replacement board powers up and enters the initial boot state, identifying itself as the backup board and sending messages to the operating board and receiving messages from the operating board. At step 418, upon receiving a message from the replacement board, the operating board clears the failure indicator, so that a subsequent cessation of messages from the replacement board will be recognized as a failure of the replacement board. At step 420, the replacement board examines messages from the operating board and compares them with its own status. Because the replacement board is identified as the backup board and the operating board is identified as the primary board, no status conflict is detected. Thus, the process proceeds to step 422 and the replacement board enters the steady state.

While the present invention has been disclosed in the context of various aspects of presently preferred embodiments, it will be recognized that the invention may be suitably applied to other environments consistent with the claims which follow.

I claim:

1. A processing system, comprising:
a pair of redundant control units, each of the units being operable as one of a primary unit active during normal operation and a backup unit operable to transition to become the operating primary unit upon failure of the failed primary unit, the primary unit being operative to detect operation of a replacement unit upon replacement of a failed primary or backup unit and to continue operating as the primary unit without undergoing any transition.

2. The system of claim 1, wherein the system receives service requests from external clients and the primary control unit directs the service requests to appropriate processing units.

3. The system of claim 3, further comprising an isolation mechanism to selectively allow the system to be isolated from and connected to the external clients.

4. The system of claim 3, wherein the isolation mechanism is a switch.

5. The system of claim 4, wherein the control units periodically transfer messages to one another, the messages transferred by a control unit including status information indicating whether the control unit is operating as the primary unit or the secondary unit.

6. The system of claim 5, wherein each of the control units, during an initial boot state entered into upon initial application of power to the control unit, identifies itself as the backup unit, examines messages from the other control unit to identify the status of the other control unit and determines whether or not a conflict exists between its own status and that of the other control unit, and wherein each of the control units performs a status negotiation upon detection of a conflict between its own status and that of the other control unit.

7. The system of claim 6, wherein each of the control units performs a status negotiation by examining a set of jumper connections.

8. The system of claim 7, wherein the system communicates with external clients in a manner that is robust to interruptions and data loss.

9. The system of claim 8, wherein the switch is an Ethernet switch providing the system with an IP address and where each of the control boards has a shared connection to the switch.

10. The system of claim 9, wherein the switch is disconnected while the backup unit undergoes a status transition to become the primary unit.

11. The system of claim 10, wherein the primary unit does not stop operation upon detection of a failure of the backup unit.

12. The system of claim 11, further including a plurality of processing units controlled by the primary control unit.

13. A control module for operation and failure recovery management of a control unit employed in a redundant system, the control unit being one of a pair of redundant control units, one of the control units serving as a primary unit and the other of the control units serving as a backup unit, comprising:
an initial boot module for initiating operation of the control unit upon initial application of power to the control unit, the initial boot module setting the initial status of the control module as the backup module;
a message transfer module for sending messages to the other control unit and receiving messages from the other control unit, the messages identifying the status of the sending control unit;
a status determination and negotiation module for establishing the operating status of the control unit, the status determination performing status negotiation upon detection of a conflict between the status of the control unit and the status of the other control unit and identifying the status of the control unit as primary or backup according to predetermined criteria; and
a steady state module for managing the control unit during normal operation; and
a failure module for managing the operation of the control unit upon detection of a failure of the other unit, the failure module invoking the status determination and negotiation module to identify the status of the control unit, leaving the status unchanged if the control unit is the primary unit and directing a transition to primary status of the control unit is the backup unit.

14. The control module of claim 13, wherein the failure module sets a failure indicator upon detecting a failure of the other unit and clears the failure indicator upon detecting that the other unit is operating.

15. The control module of claim 14, further comprising a switch control module operative to control a switch connecting the units to an external client, the switch control module disconnecting the switch during initial boot and transition from a backup to primary status and connecting the switch upon entry into normal operation.

16. The control module of claim 15, wherein the status determination and negotiation module negotiates status by examining a set of jumper connections and setting the status of the unit as indicated by the jumper connections.

17. A method of operation and failure recovery management for a redundant system including a pair of redundant units, each of the units being capable of serving as a primary unit or a backup unit, comprising the steps of:
initializing each of the units and assigning to each unit an initial status as the backup unit;
upon detection of a status conflict between the units, negotiating status between the units and assigning one of the units a status as primary unit and the other unit a status as backup unit and placing the units in a normal operational state;
upon detection by one unit of a failure by the other, examining the status of the operating unit;
if the backup unit has failed, logging the failure and continuing operation;
if the primary unit has failed, logging the failure, changing the status of the backup unit to primary and continuing operation with the operating unit as the primary unit; and
upon replacement of the failed unit, performing an initiation of the replacement unit, assigning the replacement unit with an initial status as the backup unit, recognizing the operation of the replacement unit, examining the status of the operating unit and the replacement unit and upon recognition that the status of the replacement unit and the backup unit do not conflict, clearing the failure log and beginning normal operation with the operating unit as the primary unit and the replacement unit as the backup unit.

18. The method of claim 17, further including a step of isolating the units from one or more external clients during a transition of a backup unit to a primary unit, followed by a step of restoring access by the clients to the units after the transition.

19. The method of claim 18, further including a step of transferring messages between the units, each message identifying the status of the transmitting unit as the backup unit or the primary unit and detection by one unit that the other unit has failed includes detecting that the messages from the other unit have stopped and interpreting the cessation of messages to recognize a failure of the other unit.

20. The method of claim 19, wherein the step of negotiating status between the units includes examining a set of hardware status indicators to determine which unit is to be the primary unit and which unit is to be the secondary unit.

21. A redundant system, comprising:
a first redundant unit, operative to enter an initial boot state upon initial application of power, to initially designate itself as a backup unit and to send messages to and receive messages from a second redundant unit, to compare the status indicated by the second redundant unit with its own status and to perform a status negotiation to determine whether it is to operate as primary or backup unit if the status indicated by the messages received from the second redundant unit conflict with the identification of its own status, the first redundant unit being operative to enter a steady state upon negotiation of its status, the first redundant unit being operative to enter a failure analysis mode upon detection that the second redundant unit has failed and to continue to operate as the primary redundant unit if it is already operating as primary unit and to transition to operate as the backup unit if it is operating as backup unit at the time of failure, the first unit being operative to detect replacement of the second unit and to continue operation as the primary unit after replacement of the second unit; and
the second redundant unit, the second redundant unit being operative to enter an initial boot state upon initial application of power, to initially designate itself as a backup unit and to send messages to and receive messages from the first redundant unit, to compare the status indicated by the messages received from the first redundant unit, and to perform a status negotiation to determine whether it is to operate as primary or backup unit if the messages received from the first redundant unit conflict with the identification of the second redundant unit, the second redundant unit being operative to enter a steady state upon negotiation of its status, the second redundant unit being operative to enter a failure analysis mode upon detection that the first redundant unit has failed and to continue to operate as the primary unit if it is already operating as primary unit and to transition to operate as the backup unit if it is operating as backup unit at the time of failure, the second redundant unit being operative to detect replacement of the first redundant unit and to continue operation as the primary unit after replacement of the first redundant unit.
